(19) United States
(12) Patent Application Publication
(10) Pub. No.: US 2024/0365755 A1
(43) Pub. Date: Nov. 7, 2024

(54) integrated system for fitness monitoring and tracking using a microcontroller and sensor suite with a battery module, wireless data transfer modules and charging capabilities for animals

(71) Applicant: Venkat Iyer, Phoenix, AZ (US)

(72) Inventor: Venkat Iyer, Phoenix, AZ (US)

(21) Appl. No.: 18/142,693

(22) Filed: May 3, 2023

(51) Int. Cl. A01K 27/00; A01K 11/00; A01K 29/00

(52) U.S. Cl. CPC A01K 29/005

(57) ABSTRACT

The present invention discloses an advanced pet-monitoring system including at least one of wearable component and the connected user device. The system utilizes data collected from each of these components as well as the state of any connections between the devices to (i) make various determinations about the pet's health and environment; (ii) notify the user of substantial changes in the pet's health and environment; and (iii) track the location of the pet.

### COPYRIGHT NOTICE

A portion of the disclosure of this patent document contains material which is subject to copyright protection. The copyright owner has no objection to the facsimile reproduction by anyone of the patent disclosure, as it appears in the Patent and Trademark Office patent files or records, but otherwise reserves all copyright rights whatsoever.

### BACKGROUND

### Field of the Invention

This invention is related to a technologically advanced device, low-power consumption apparatus, meticulously integrated with mobile applications, that is primarily engineered to observe the activities of animals and furnish vital data to a sophisticated, critical response system. This energy-efficient device boasts an extended battery life, ensuring uninterrupted functionality. The system is proficient in the acquisition and dissemination of pertinent information while simultaneously maintaining a vigilant watch over the animal's fitness regimen, thereby establishing a comprehensive and efficient solution for animal health monitoring and management with minimal energy expenditure.

### Description of the Related Art

A number of wearable electronics have been designed for humans. Many of these “wearables” are focused on health and wellness. These fitness wearables are typically in the form of a bracelet and are designed to collect information from the user. These fitness wearables monitor the activity and heart rate of the user using a gyroscope and/or heart rate sensor and transmit that data to the user.

Other wearables are focused on connectivity. These wearables are typically in the form of a “smartwatch” and are designed to present information from the user's smartphone to the user. These smartwatches receive notifications from the user's smartphone via Bluetooth or from a server via Wi-Fi, alert the user with a sound or vibration and then present that notification visually on a screen.

Still other wearables provide a measure of interactivity. For example, many of the more feature-packed smartwatches allow the user to answer phone calls using a built-in microphone and speaker. In another example, many of the more feature-packed smartwatches allow the user to update their location to the connected devices, or track the location of their loved ones. Many of these feature-packed smartwatches also incorporate the fitness components of provided by fitness wearables.

However, very little innovation is been seen in case of pets. Preventing domesticated house pets from straying away from human supervision or their home is a serious concern for many owners. Dogs in particular can wander away or stray without concern for their home when left alone outside of the home or when an entryway is left open. To ensure safety of the pet and prevent the pet from becoming lost, most owners keep their pet indoors, enclosed within a fenced area or tethered to a location or run line such that they are prohibited from wandering away. However, such means of containment are not foolproof, particularly if the animal is left unattended for long periods of time, wherein the animal may find a way to escape a fenced area, find holes in an electric fence or disengage from a tether device. For this reason, animal identification collars generally include the animal's and their owner's contact information, such that retrieval of the animal is possible after being corralled or taken in by another individual. This allows the owner to be contacted or authorities to locate the animal's home.

Basic animal collars are necessary devices for identifying the animal and the owner's information; however they are less than effective for locating the animal while it is still loose or engaging in communication therewith during this period. More advanced means of tracking stray animals include subcutaneously imbedded identification chips, which allow authorities to identify the animal and its owners without a collar being present. More advanced collar devices include radio communication with a base station as to the proximity of the animal, while still further advanced collars include imbedded Global Positioning System (GPS) connectivity for locating the animal over greater distances. These advanced collars also include the animal and owner identifying information to be electronically stored and retrieved after the animal is found. The present invention relates to a more advanced animal collar and communication device, wherein a new dog communication collar is provided having a cellular network connectivity in which an owner, trainer or controller is able to have direct communication with the animal and a means for directly tracking its movement utilizing a cellular phone device, which is a significant improvement in the art of animal tracking, communication and retrieval collars.

Example situations in which direct animal communication and electronic identification may be required include instances in which the animal strays from its home and becomes lost. This is possible if the pet is left unattended for long periods and is able to test its boundaries, as in the case of when an owner is away at work, on vacation, or is less than diligent with regards to the animal's status. If the animal is left unattended in an outdoor environment, such as a large backyard, the animal, and in particular dogs, may burrow beneath fences, find weakness or openings in a physical fence or further learn when an electric fence is disengaged due to a power outage or learn of a gap in the electric fence perimeter. Further still are situations in which a pet is taken into open spaces and allowed to play freely, such as open parks and recreation areas. If the animal decides to run away, the owner has little recourse but to chase after the animal. Once a sufficient gap is achieved between the two, tracking and direct communication with the animal becomes extremely difficult or further impossible if the animal leaves the vicinity. The present invention is intended to improve overall communication with a given animal in such situations wherein the animal has strayed from its home and retrieval is desired.

By looking at prior art, multiple advancements have been seen in similar regards. For instance, a U.S. Pat. No. 6,874,447 to Kobett describes a method and apparatus for tracking and controlling a hunting dog within a given proximity to a hunter, wherein communication is established between the dog and a hunter via a receiving handset and a remote transmitter assembly carried by the dog. A transceiver in electric communication with an enunciator, wherein audible commands can be wireless transmitted between the hunter and dog for controlling the dog during a hunt within a given separation distance. Audible tones and voice commands are transmitted to the remote assembly, adapted to provide improved communication between the dog and hunter. The Kobett device is adapted to provide a unique handset that allows voice transmission and tones to be sent to a hunting dog during a hunting event, providing improved control thereof to facilitate hunting of other animals. This device relates more closely to a two-way radio and proximity tracking device, as opposed to a device of the present invention in which cellular connectivity is employed to facilitate tracking and voice communication with the hunting dog. The present invention further provides an imbedded GPS transponder when access to a cellular network is not possible, such as a hunting expedition in more remote locations. This allows an owner to track and to communicate with their dog over greater distances, facilitating recovery of a lost pet or active communication during a hunting activity. The device further provides a leash having elements that improve visibility and information about the pet if ever lost. The intent of the present invention diverges from the Kobett device, along with structural elements and electrical components.

U.S. Pat. No. 6,067,018 to Skelton is another device that discloses a pet remote monitoring system that automatically activates an alarm when a pet becomes lost, alerting an owner that a pet has left a certain area via a wireless signal that relays to a base station. A portable unit is provided that attaches to the pet to allow tracking thereof over cellular networks or via GPS. Once the pet has left a predefined area, a signal is sent to the base station. The base station then places a telephone call to the pet owner for notification purposes. The device further provides a tracking means that utilizes cellular networks to transmit registration messages in order to triangulate the collar position. While providing a means to locate a pet using a cellular emulator that transmits signals to a cellular network, the Skelton device does not allow direct communication between a pet owner/operator and the given animal over a cellular network. The Skelton device further requires a base station in order to facilitate a phone message to the owner in the even the animal has strayed from a given zone. While utilizing a cellular network to transmit location, the present invention is a more advanced means of communication and location determination. The present invention utilizes direct cellular communication to control, track and visualize a given animal.

Further, U.S. Pat. No. 7,411,492 to Greenberg describes a tracking system that includes GPS and a modem for tracking a pet once the pet has wandered beyond the boundaries of an established virtual fence. The virtual fence is a portable system that sends a signal based on a to-be-fenced pet or individual that alerts a breach of the fence boundary, activating the system to begin tracking. The Greenberg device is primarily tracking a person, pet or item within a defined area and alerting/locating a user via a modem for mobile communications that sends a signal to base station. This device is primarily for tracking items within a local area and ensuring the target item does not leave the confines thereof. The present invention is intended as a multi-use collar that can be used for tracking a lost pet, providing a means to locate and communicate with a hunting dog and for establishing direct communication between a Samaritan and an owner who may have lost a pet.

Similar in nature to the Greenberg device is Published Patent Application Publication Number 2007/0204804 to Swanson, which discloses a pet containment system that relies on GPS tracking to determine the direction of travel within a perimeter boundary to determine whether a corrective shock is administered. An accelerometer and GPS device within a dog collar determine if a dog or similar animal has breached a perimeter fence, and thereafter does not shock the animal once the animal attempts to return to its keeping area. Utilization of the Swanson device eliminates the need to burry a perimeter hidden fence, and further eliminates those situations in which a dog breaches the fence and is trapped on the outside without confusing shocks when trying to re-enter. The present invention provides a cellular connectivity collar of differing intent and spirit. The elements of present invention are further divergent from the Swanson device, which is adapted to administer ‘corrective’ shocks to contain an animal within a given area. The present invention provides a means to locate and retrieve a lost pet or communicate with a hunting animal.

Finally, U.S. Published Patent Application Publication Number 2002/0021219 to Edwards discloses an animal tracking collar that utilizes a GPS signal and broadband wireless communication networks to locate and stream live video from the point of view of the collar to a remote computing device. The use of both GPS coordinates and a view of from the lost animal allows an owner or tracker to quickly locate and retrieve the animal if lost or strayed. The Edwards device provides a novel means of further informing an owner or individual in search of a pet, however it fails to consider the capabilities provided by the present invention. In particular, the present invention provides a means to locate a lost pet or to communicate with a hunting dog during an outing. The elements of the present invention provide several means to locate, communicate with and retrieve an animal using an advanced collar system that can communicate over cellular networks with an owner or master.

Another application of the present invention relates to a fitness tracking system specially designed for animals. The proposed system fitness and tracking device monitors and saves activity levels, including location data of the animals that wears it. The device is used to track an animal's activity levels, which can then help owners monitor their animal's fitness and health and also track their location.

None of the previous inventions and patents, taken either singly or in combination, is seen to describe the instant invention as claimed. Hence, the inventor of the present invention proposes to resolve and surmount existent technical difficulties to eliminate the aforementioned shortcomings of prior art.

### SUMMARY

In light of the disadvantages of the prior art, the following summary is provided to facilitate an understanding of some of the innovative features unique to the present invention and is not intended to be a full description. A full appreciation of the various aspects of the invention can be gained by taking the entire specification, claims, drawings, and abstract as a whole.

The primary desirable object of the present invention is to provide a novel and improved form of the system allowing to monitor of the activities and location tracking of animals.

It is also the primary objective of the invention to provide an activity and sleep monitoring and location tracking module.

It is another objective of the invention to provide a smart system that provides the animal's location and identifying information to concerned people automatically.

It is also the objective of the invention to provide a device that works by using the gyroscope and accelerometer to track animal activity levels, and uses a GPS module to track the location.

It is another objective of the invention to provide a smart device that connects to smart devices through the associated application.

It is a further objective of the invention to provide an emergency response system that provides exact mapping and necessary information of the animal.

It is also the objective of the system to provide location tracking data in case of emergency, thus acting as a device with a well-managed emergency response system.

A further object is to provide an assembly that is convenient and easy to use.

It is moreover the objective of the invention to provide a technologically advanced and low-power consumption apparatus.

Still yet another object of the present invention is to provide a new and improved fitness monitoring and location tracking system for animals, which provides in the apparatuses and methods of the prior art some of the advantages thereof, while simultaneously overcoming some of the disadvantages normally associated therewith.

Other aspects, advantages and novel features of the present invention will become apparent from the detailed description of the invention when considered in conjunction with the accompanying drawings.

This Summary is provided merely for purposes of summarizing some example embodiments, so as to provide a basic understanding of some aspects of the subject matter described herein. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### DETAILED DESCRIPTION

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

The present invention is directed to a wearable device specially designed for animals allowing the owners to monitor their activity level and also to track their location.

The assembly as per illustrative embodiment is a fitness-tracking system wherein it involves a microcontroller, wireless module, gyroscope, and accelerometer to track the activity level and calculate the resultant fitness level of an animal.

In one embodiment, the method comprises of the steps of: at least one monitoring module for collecting data about an animal; at least one communication module for communicating the collected data with one of a base station, user device or network; a battery; and a processor that determines whether the at least one communication module is connected to one of the base station, user device or network and, based on that determination, determines the location of the animal relative to one of the base station and the user device.

In one embodiment, the apparatus comprises of: collecting data about an animal using a wearable component; communicating the collected data with one of the base stations, user device or network; and determining whether the wearable component is connected to one of the base stations, a user device or network and, based on said determination, determining the location of the animal relative to one of the base station and the user device.

In another embodiment, the method comprises the steps of: collecting data about an animal using a wearable component; communicating the collected data with at least a connected user device; and determining whether the wearable component is connected to at least one user device and attributing the collected data to a profile corresponding to the connected user device.

In other embodiments, an application is provided that allows connecting the user's smart devices with the wearable device. The online system has focused components and is based on simple to use. The online system can be viewed and used from a personal computer, laptop, PDA or any computing device. In order to use the web-based application the user has to be connected to the internet to use the features in real-time. For real-time utility needs to be connected to the internet through local area networks (“LANs”)/wide area networks (“WANs”), wireless networks or independent internet sources. Further, the internet would connect the user to the online feedback application server, through the user's computing or mobile device, where applicable.

Generally, the client device may include virtually any computing device capable of receiving and sending a message over a network, such as LAN/WAN or independent network, wireless network, and the like, to and from another computing device, such as server or mobile device, and the like. The set of such devices may include devices that typically connect using wired communication mediums such as personal computers, multiprocessor systems, microprocessor-based or programmable consumer electronics, network PCs, and the like. The set of such devices may also include devices that typically connect using a wireless communications medium such as cell phones, smart phones, Tablets or PDAs. Similarly, client device may be any device that is capable of connecting using a wired or wireless communication medium such as a PDA, POCKET PC, wearable computer, and any other device that is equipped to communicate over a wired and/or wireless communication medium.

Client devices may include a browser application that is configured to receive and to send web pages, web-based messages, and the like. The browser application may be configured to receive and display graphics, text, multimedia, and the like, employing virtually any web-based language, including Standard Generalized Markup Language (SMGL), HyperText Markup Language (HTML), and so forth.

Client devices may also include mobile computing devices especially smartphones, which allow the user to download the application and use it on one click. The online website has a responsiveness mode for the application to function in full on the mobile computing device. Any mobile computing device can be used by the user for using the application. Such devices include portable devices such as, cellular telephones, smartphones, Personal Digital Assistants (PDAs), handheld computers, wearable computers, tablet computers, integrated devices combining one or more of the preceding devices, and the like.

While a specific embodiment has been shown and described, many variations are possible. With time, additional features may be employed. The particular shape or configuration of the platform or the interior configuration may be changed to suit the system or equipment with which it is used.

Having described the invention in detail, those skilled in the art will appreciate that modifications may be made to the invention without departing from its spirit. Therefore, it is not intended that the scope of the invention be limited to the specific embodiment illustrated and described. Rather, it is intended that the scope of this invention be determined by the appended claims and their equivalents.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

1. A system for monitoring an animal, comprising: a user device associated with a user; and an animal collar device comprising at least one monitoring component configured to collect data about the animal, at least one communication component configured to communicate the data about the animal to said user device, a battery coupled to said at least one monitoring component and said at least one communication component, and a processor coupled to said battery and configured to determine whether said at least one communication component is connected to at least one of said user device to provide a location of the animal and the fitness information of the animal.

2. The system as per claim 1, wherein includes a gyroscope, accelerometer, and other similar devices to monitor the activity level of the animal.

3. The system as per claim 1, wherein includes a gyroscope, accelerometer, and other similar devices to monitor the sleep level of the animal.

4. The system as per claim 1, wherein includes a GPS tracking module to notify the location of the animal.

5. The system as per claim 1, wherein includes modules that can be controlled by the settings, and power consumption can be regulated by turning on and off the modules, and adjusting the frequency of sampling based on the use case.

6. The system as per claim 1, wherein includes a USB Type-C charging port that allows charging the device.

7. The system as per claim 1, wherein includes a communication module to transfer the information to coupled user's device.

8. The system as per claim 1, wherein provides a low-power consumption apparatus primarily engineered to observe the activities of animals.

9. The system as per claim 1, wherein provides energy-efficient device boasts an extended battery life, ensuring uninterrupted functionality
